(19) United States
(12) Patent Application Publication
(10) Pub. No.: US 2019/0387272 A1
(43) Pub. Date: Dec. 19, 2019

(54) DISPLAY DEVICE AND METHOD OF CONTROLLING DISPLAY DEVICE

(71) Applicant: SEIKO EPSON CORPORATION, Tokyo (JP)

(72) Inventor: Kazuki NAGAI, Azumino-shi (JP)

(73) Assignee: SEIKO EPSON CORPORATION, Tokyo (JP)

(21) Appl. No.: 16/441,073

(22) Filed: Jun. 14, 2019

(30) Foreign Application Priority Data
Jun. 15, 2018 (JP) 2018-114878

(51) Int. Cl. H04N 21/439; H04N 21/41; H04N 21/4363

(52) U.S. Cl. CPC H04N 21/4394; H04N 21/43637; H04N 21/4122

(57) ABSTRACT

A display device includes a receiving section configured to wirelessly receive stream data including video data and audio data, a separation section configured to separate the video data and the audio data from the stream data, a display processing section configured to display an image based on the video data, and an output processing section configured to output the audio data to a sound output device to be connected with wire.

The present application is based on, and claims priority from JP Application Serial Number 2018-114878, filed Jun. 15, 2018, the disclosure of which is hereby incorporated by reference herein in its entirety.

### BACKGROUND

### 1. Technical Field

The present disclosure relates to a display device and a method of controlling a display device.

### 2. Related Art

When a display device such as a projector is used for, for example, a home theater, the display device receives a video signal and a sound signal from an image reproduction device such as a DVD (digital versatile disk) player. For example, the projector incorporating speakers displays an image based on the video signal, and at the same time outputs a sound based on the sound signal from the speakers thus incorporated. It should be noted that when the speakers incorporated in the projector are not used, or when no speaker is incorporated in the projector, for example, external speakers are used as a sound output device for outputting the sound. In JP-A-2005-210449, there is disclosed a system in which the projector and the DVD player are connected wirelessly to each other, and the DVD player and the external speakers are connected to each other with wire.

Further, there is known a projector having a function of Miracast. It should be noted that Miracast is a registered trademark. The projector having the function of Miracast wirelessly receives stream data including video data as data of an image and audio data as data of a sound, and then displays the image based on the video data and outputs the sound based on the audio data from the speakers incorporated in the projector.

However, in the related-art projector, the video data and the audio data are included in the stream data received wirelessly in series, and it is difficult to output only the audio data to the external speakers with wire.

### SUMMARY

A display device according to an aspect of the present disclosure includes a receiving section configured to wirelessly receive stream data including video data and audio data, a separation section configured to separate the video data and the audio data from the stream data, a display processing section configured to display an image based on the video data, and an output processing section configured to output the audio data to a sound output device to be connected with wire.

A method of controlling a display device according to another aspect of the present disclosure is a method of controlling a display device to be connected to a sound output device with wire, the method including the steps of receiving wirelessly stream data including video data and audio data, separating the video data and the audio data from the stream data, displaying an image based on the video data, and outputting the audio data to the sound output device.

### BRIEF DESCRIPTION OF THE DRAWINGS

FIG. 1 is an explanatory diagram of a display device according to a first embodiment of the present disclosure.

FIG. 2 is a block diagram showing a configuration of a display device according to the first embodiment.

FIG. 3 is a flowchart showing an example of an operation of the display device according to the first embodiment.

FIG. 4 is a block diagram showing a configuration of a display device according to a second embodiment.

FIG. 5 is a block diagram showing a configuration of a display device according to a third embodiment.

FIG. 6 is an explanatory diagram of a delay amount of audio data delayed by a delay section.

FIG. 7 is a block diagram showing a configuration of a display device according to a fourth embodiment.

FIG. 8 is a block diagram showing a configuration of a display device according to a fifth embodiment.

FIG. 9 is a block diagram showing a configuration of a display device according to a sixth embodiment.

### DESCRIPTION OF EXEMPLARY EMBODIMENTS

Hereinafter, some embodiments will be described with reference to the drawings. It should be noted that in the drawings, the size and the scale of each of the constituents are arbitrarily different from actual ones. The present embodiments are each provided with a variety of technically preferable limitations. However, the scope of the present disclosure is not at all limited to these embodiments.

### First Embodiment

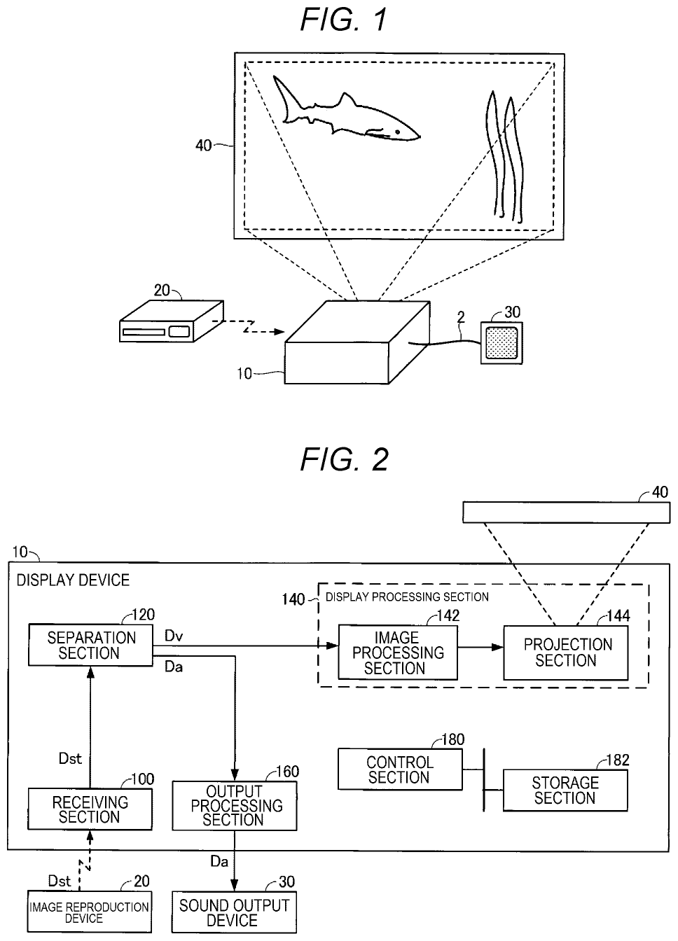

A first embodiment of the present disclosure will be described with reference to FIG. 1 through FIG. 3. FIG. 1 is an explanatory diagram of a display device 10 according to the first embodiment of the present disclosure. The display device 10 shown in FIG. 1 is wirelessly connected to an image reproduction device 20, and is connected to a sound output device 30 in a wired manner using a cable 2. For example, the display device 10 is a projector including a function of reproducing stream data transmitted using a display transmission technology with wireless communication. It should be noted that the stream data includes video data as data of an image and audio data as data of a sound. Further, as a technology for wirelessly transmitting the stream data, it is configured to use, for example, Miracast, WirelessHD, AirPlay, WHDI (Wireless Home Digital Interface), WiGig and so on. WirelessHD, AirPlay and WiGig are each a registered trademark.

For example, the display device 10 wirelessly receives the stream data from the image reproduction device 20, and projects the image based on the video data included in the stream data on a screen 40 to display the image, and outputs the audio data included in the stream data to the sound output device 30. As a result, the sound corresponding to the image displayed on the screen 40 is output from the sound output device 30. The number of the sound output devices 30 to be connected to the display device 10 can be one, or can also be two or more. Therefore, the number of the cables 2 to be connected to the display device 10 can be one, or can also be two or more. It should be noted that the details of the display device 10 will be described with reference to FIG. 2.

The image reproduction device 20 is, for example, a DVD player having a function of wirelessly transmitting the stream data, and wirelessly transmits the stream data which includes data of the image or the like to be displayed on the screen 40 to the display device 10. It should be noted that the image reproduction device 20 can also be a Blu-ray disk player, a hard disk recorder, a television tuner device, a set-top box for cable television, a personal computer, a smartphone, a video game device or the like providing the image reproduction device 20 has a function of wirelessly transmitting the stream data. Blue-ray is a registered trademark.

The sound output device 30 has a function of reproducing a sound from audio data. The function of reproducing the sound from the audio data includes a function of decoding the audio data, a function of converting a digital signal into an analog signal, a function of generating a sound wave based on the analog signal, and so on. The sound output device 30 can also include an AV amplifier, a D/A converter, or a speaker. The sound output device 30 reproduces a sound based on the audio data received from the display device 10 via the cable 2 and outputs the sound. The cable 2 is a cable compatible with the transmission of digital audio data. For example, the cable 2 can be an optical cable compliant with the SPDIF (Sony Philips Digital Interface) standard, or a coaxial cable, or can also be an HDMI (High Definition Multimedia Interface) cable. HDMI is a registered trademark.

FIG. 2 is a block diagram showing a configuration of the display device 10 according to the first embodiment. The display device 10 has a receiving section 100, a separation section 120, a display processing section 140, an output processing section 160, a control section 180 and a storage section 182.

The receiving section 100 is a wireless communication interface such as a wireless LAN. The receiving section 100 wirelessly receives the stream data Dst including the video data Dv and the audio data Da from the image reproduction device 20. For example, in Miracast, the video data Dv compliant with H.264 and the audio data Da compliant with LPCM (Linear Pulse Code Modulation) or the like are multiplexed using MPEG2-TS (Moving Picture Experts Group 2 Transport Stream). Therefore, when Miracast is used as the wireless data transmission technology, the receiving section 100 receives the stream data Dst which is generated by multiplexing the video data Dv compliant with H.264 and the audio data Da compliant with LPCM or the like into MPEG2-TS. Then, the receiving section 100 transmits the stream data Dst to the separation section 120.

The separation section 120 separates the video data Dv and the audio data Da from the stream data Dst received from the receiving section 100. For example, the separation section 120 performs time-division demultiplexing on the stream data Dst in which time-division multiplexing is performed on the video data Dv and the audio data Da, to thereby output the video data Dv and the audio data Da. Then, the separation section 120 transmits the video data Dv to the display processing section 140, and transmits the audio data Da to the output processing section 160.

The display processing section 140 displays the image based on the video data Dv received from the separation section 120 on the screen 40. For example, the display processing section 140 has an image processing section 142 and a projection section 144.

The image processing section 142 has a function of decoding the video data Dv which is encoded so as to be compliant with a video compression standard such as H.264. For example, the image processing section 142 decodes the video data Dv received from the separation section 120 to generate the data of the image to be displayed on the screen 40. Then, the image processing section 142 transmits the data of the image to be displayed on the screen 40 to the projection section 144. It should be noted that the image processing section 142 can also perform image processing such as a resolution conversion process for converting the resolution, a color compensation process for adjusting the luminance and the chroma, or a keystone correction process for correcting the keystone distortion of the image to be projected on the screen 40.

The projection section 144 projects the image based on the data received from the image processing section 142 on the screen 40 to thereby display the image. For example, the projection section 144 drives liquid crystal light valves not shown in the projection section 144 based on the data of the image received from the image processing section 142. Then, the liquid crystal light valves in the projection section 144 modulate light emitted from a light source not shown in the projection section 144 to generate image light. By the image light being projected from the projection section 144 on the screen 40, the image is displayed on the screen 40. In other words, the projection section 144 projects the image light generated based on the data of the image received from the image processing section 142 on the screen 40 to thereby display the image based on the video data Dv on the screen 40.

The output processing section 160 outputs the audio data Da received from the separation section 120 to the sound output device 30 connected with wire. For example, the output processing section 160 is connected to the sound output device 30 using the cable 2, and functions as an interface for outputting the audio data Da to the sound output device 30. The sound output device 30 reproduces a sound from the audio data Da received from the output processing section 160 via the cable 2. In other words, the display device 10 makes the sound corresponding to the image to be displayed on the screen 40 be output from the sound output device 30. For example, the display device 10 and the sound output device 30 respectively reproduce the image and the sound based on the time stamp included in the stream data Dst to thereby synchronize the image and the sound with each other.

The control section 180 is a computer such as a central processing unit (CPU) for controlling the operation of the display device 10. The control section 180 can also be provided with one processor, or a plurality of processors. The control section 180 retrieves and then performs a program stored in the storage section 182 to thereby control operations of the respective blocks such as the receiving section 100 in the display device 10. It should be noted that in FIG. 2, the description of control lines for respectively connecting the control section 180 to the receiving section 100, the separation section 120, the image processing section 142, the projection section 144 and the output processing section 160 is omitted in order to make the drawing eye-friendly.

As shown in FIG. 2, the display device 10 is configured to output only the audio data Da with wire to the sound output device 30 as an external device out of the video data Dv and the audio data Da included in the stream data Dst wirelessly received in series. As a result, in the display device 10, it is configured to make the sound corresponding to the image to be displayed on the screen 40 be output from the sound output device 30 as an external device to thereby enhance usability such as user-friendliness. For example, in the case of receiving the stream data Dst including the multichannel audio data Da, it is configured for the display device 10 to allow the user to easily listen to the sound with feeling of presence by outputting the audio data Da to the sound output device 30 such as an AV amplifier compatible with the multichannel sound output.

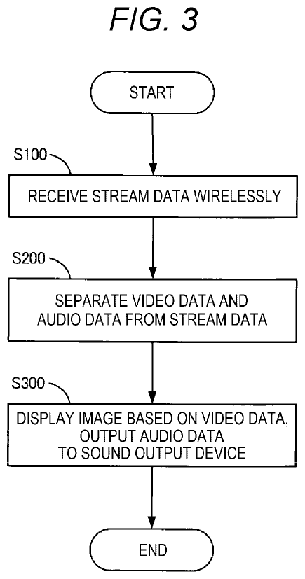

FIG. 3 is a flowchart showing an example of an operation of the display device 10 according to the first embodiment. The operation shown in FIG. 3 is an example of a method of controlling the display device 10.

Firstly, in the step S100, the display device 10 wirelessly receives the stream data Dst including the video data Dv and the audio data Da from the image reproduction device 20.

Then, in the step S200, the display device 10 separates the video data Dv and the audio data Da from the stream data Dst .

Then, in the step S300, the display device 10 displays the image based on the video data Dv on the screen 40, and outputs the audio data Da to the sound output device 30. Due to the process in the step S300, the image based on the video data Dv included in the stream data Dst is displayed on the screen 40, and the sound corresponding to the image to be displayed on the screen 40 is output from the sound output device 30.

As described hereinabove, in the first embodiment, the display device 10 has the receiving section 100, the separation section 120, the display processing section 140 and the output processing section 160. The receiving section 100 wirelessly receives the stream data Dst including the video data Dv and the audio data Da. The separation section 120 separates the video data Dv and the audio data Da from the stream data Dst. Then, the display processing section 140 displays the image based on the video data Dv. Further, the output processing section 160 outputs the audio data Da to the sound output device 30 connected with wire. In other words, the display device 10 is configured to output only the audio data Da with wire to the sound output device 30 as an external device out of the video data Dv and the audio data Da included in the stream data Dst received wirelessly. As a result, according to the display device 10, it is configured to enhance the usability such as the user-friendliness.

### Second Embodiment

A major difference between the second embodiment and the first embodiment is a point that the format of audio data Da2 to be output to the sound output device 30 can be changed from the format of the audio data Da included in the stream data Dst.

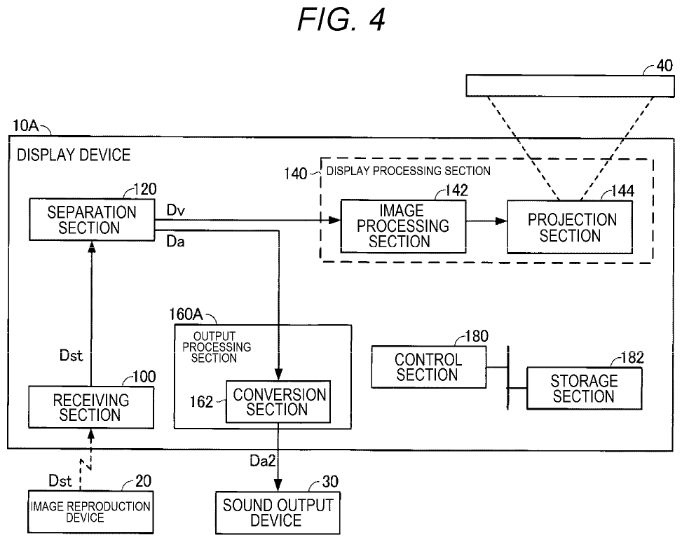

FIG. 4 is a block diagram showing a configuration of a display device 10A according to the second embodiment. The same elements as the elements having already been described with reference to FIG. 1 through FIG. 3 are denoted by the same reference numerals and the detailed description thereof will be omitted. The display device 10A is the same as the display device 10 of the first embodiment except the fact that an output processing section 160A is provided instead of the output processing section 160 shown in FIG. 2. For example, the display device 10A has the receiving section 100, the separation section 120, the display processing section 140, the output processing section 160A, the control section 180 and the storage section 182. The receiving section 100, the separation section 120, the display processing section 140, the control section 180 and the storage section 182 are the same as those of the first embodiment. Therefore, in FIG. 4, the description will be presented with a focus on the output processing section 160A. It should be noted that also in FIG. 4, the description of control lines for respectively connecting the control section 180 to the receiving section 100, the separation section 120, the image processing section 142, the projection section 144 and the output processing section 160A is omitted in order to make the drawing eye-friendly.

In the example shown in FIG. 4, the display device 10A is connected to the sound output device 30 with an HDMI cable compatible with Audio Return Channel. In other words, in the second embodiment, the cable 2 shown in FIG. 1 is the HDMI cable compatible with Audio Return Channel, and the output processing section 160A functions as an interface compatible with Audio Return Channel of the HDMI cable. Hereinafter, Audio Return Channel is also referred to as ARC (Audio Return Channel).

For example, the output processing section 160A has a conversion section 162 for converting the audio data Da into a format compatible with ARC of the HDMI cable. Then, the output processing section 160A outputs the audio data Da2 in the format compatible with ARC of the HDMI cable to the sound output device 30. The format compatible with ARC of the HDMI cable is, for example, SPDIF.

For example, the conversion section 162 converts the format of the audio data Da received from the separation section 120 into the format compatible with ARC of the HDMI cable to thereby generate the audio data Da2. Then, the conversion section 162 outputs the audio data Da2 to the sound output device 30 via the HDMI cable compatible with ARC. It should be noted that when the format of the audio data Da included in the stream data Dst is the format compatible with ARC of the HDMI cable, the output processing section 160A outputs the audio data Da received from the separation section 120 to the sound output device 30 as the audio data Da2 without converting the format.

As described hereinabove, also in the second embodiment, substantially the same advantages as in the first embodiment can be obtained. Further, in the second embodiment, the output processing section 160A has the conversion section 162 for converting the audio data Da into the format compatible with ARC of the HDMI cable, and outputs the audio data Da2 in the format compatible with ARC of the HDMI cable to the sound output device 30. Therefore, in the display device 10A, it is configured to make the sound corresponding to the image to be displayed on the screen 40 be output from the sound output device 30 compatible with ARC of the HDMI cable to thereby enhance the usability such as the user-friendliness.

### Third Embodiment

A major difference between the third embodiment and the second embodiment is a point that the audio data Da is delayed.

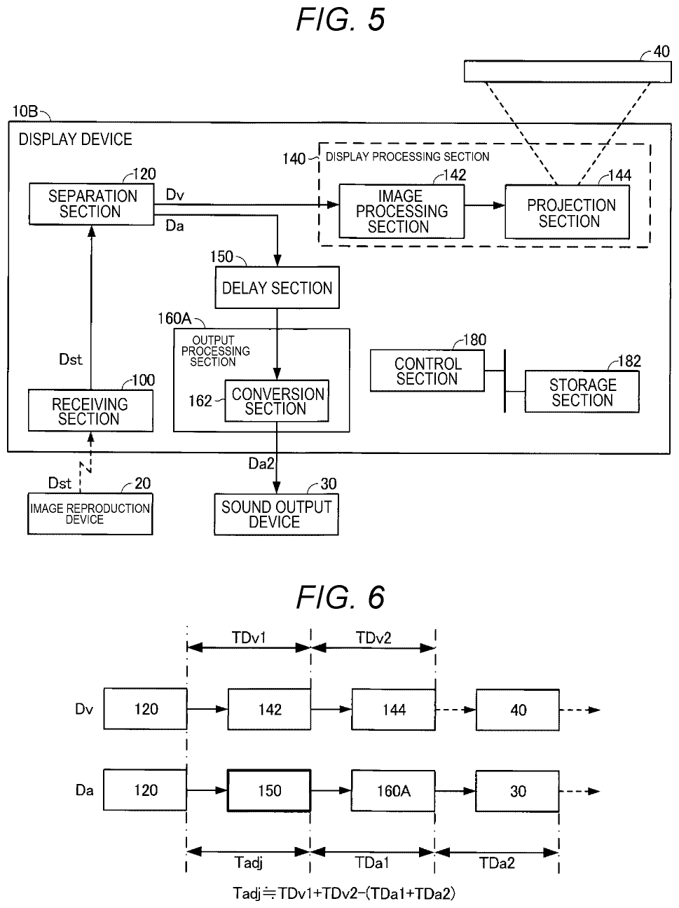

FIG. 5 is a block diagram showing a configuration of a display device 10B according to the third embodiment. The same elements as the elements having already been described with reference to FIG. 1 through FIG. 4 are denoted by the same reference numerals and the detailed description thereof will be omitted. The display device 10B is the same as the display device 10A shown in FIG. 4 except the point that a delay section 150 is added to the display device 10A shown in FIG. 4. For example, the display device 10B has the receiving section 100, the separation section 120, the display processing section 140, the delay section 150, the output processing section 160A, the control section 180 and the storage section 182. The receiving section 100, the separation section 120, the display processing section 140, the output processing section 160A, the control section 180 and the storage section 182 are the same as those of the second embodiment. Therefore, in FIG. 5, the description will be presented with a focus on the delay section 150. It should be noted that also in FIG. 5, the description of control lines for respectively connecting the control section 180 to the receiving section 100, the separation section 120, the projection section 144 and the output processing section 160A is omitted in order to make the drawing eye-friendly.

The delay section 150 receives the audio data Da from, for example, the separation section 120. Then, the delay section 150 delays the audio data Da received from the separation section 120 and then outputs the result to the output processing section 160A. Specifically, the delay section 150 delays the audio data Da which has been separated from the video data Dv.

For example, the delay amount of the audio data Da delayed by the delay section 150 is set in advance in accordance with the specification of the display device 10B and so on so that an output delay time of the sound and an output delay time of the image are aligned with each other. The output delay time of the sound is, for example, the time from when the video data Dv and the audio data Da are separated from each other by the separation section 120 to when the sound is output from the sound output device 30. Further, the output delay time of the image is, for example, the time from when the video data Dv and the audio data Da are separated from each other by the separation section 120 to when the image light is projected from the projection section 144. Further, the specification of the display device 10B related to setting of the delay amount of the audio data Da is, for example, the luminance when the display device 10B projects an image or the content of the image processing performed by the image processing section 142.

FIG. 6 is an explanatory diagram of the delay amount of the audio data Da delayed by the delay section 150. A first video delay time TDv1 represents a processing time from when the image processing section 142 receives the video data Dv to when the image processing section 142 outputs the data of the image to be displayed on the screen 40. For example, the first video delay time TDv1 includes the processing time of the image processing performed by the image processing section 142. A second video delay time TDv2 represents a processing time from when the projection section 144 receives the data of the image from the image processing section 142 to when the projection section 144 projects the image light. Therefore, the sum of the first video delay time TDv1 and the second video delay time TDv2 corresponds to the output delay time of the image.

An adjusting delay time Tadj represents a time from when the audio data Da is output from the separation section 120 to when the audio data Da reaches the output processing section 160A. A first audio delay time TDa1 represents a processing time from when the output processing section 160A receives the audio data Da to when the output processing section 160A outputs the audio data Da2. For example, the first audio delay time TDa1 includes the processing time of the conversion process performed by the conversion section 162. A second audio delay time TDa2 represents a processing time from when the sound output device 30 receives the audio data Da2 to when the sound output device 30 outputs the sound. Therefore, the sum of the adjusting delay time Tadj, the first audio delay time TDa1 and the second audio delay time TDa2 corresponds to the output delay time of the sound.

For example, the delay amount of the audio data Da delayed by the delay section 150 is set in advance so that the adjusting delay time Tadj approaches a value expressed by the formula (1). As a result, it is configured for the delay section 150 to delay the audio data Da so that the output delay time of the sound and the output delay time of the image are aligned with each other.

Tadj=TDv1+TDv2−(TDa1+TDa2) (1)

As described hereinabove, also in the third embodiment, substantially the same advantages as in the second embodiment can be obtained. Further, in the third embodiment, the delay section 150 delays the audio data Da which has been separated from the video data Dv. For example, the delay section 150 delays the audio data Da so that the output delay time of the sound and the output delay time of the image are aligned with each other. As a result, it is configured for the display device 10B to prevent the image to be displayed on the screen 40 and the sound to be output from the sound output device 30 from being shifted from each other.

### Fourth Embodiment

A major difference between the fourth embodiment and the third embodiment is a point that the delay amount of the audio data Da is adjusted in accordance with the content of the image processing by the image processing section 142.

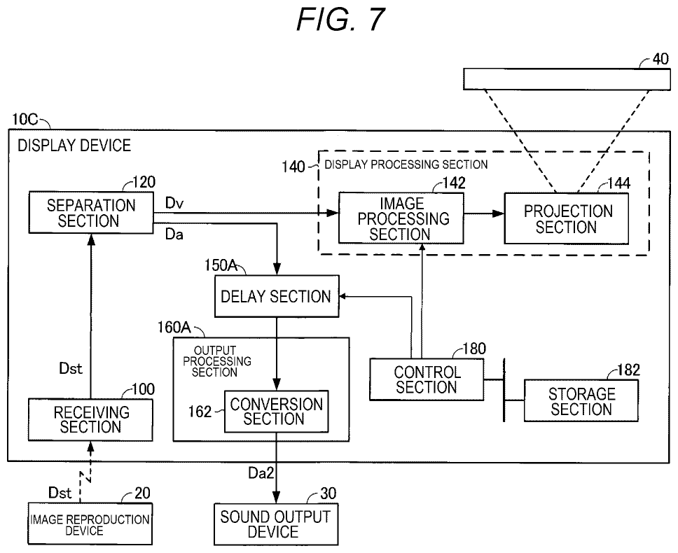

FIG. 7 is a block diagram showing a configuration of a display device 10C according to the fourth embodiment. The same elements as the elements having already been described with reference to FIG. 1 through FIG. 6 are denoted by the same reference numerals and the detailed description thereof will be omitted. The display device 10C is the same as the display device 10B shown in FIG. 5 except the fact that a delay section 150A is provided instead of the delay section 150 shown in FIG. 5. For example, the display device 10C has the receiving section 100, the separation section 120, the display processing section 140, the delay section 150A, the output processing section 160A, the control section 180 and the storage section 182. The receiving section 100, the separation section 120, the display processing section 140, the output processing section 160A, the control section 180 and the storage section 182 are the same as those of the third embodiment. Therefore, in FIG. 7, the description will be presented with a focus on the delay section 150A. It should be noted that also in FIG. 7, the description of control lines for respectively connecting the control section 180 to the receiving section 100, the separation section 120, the projection section 144 and the output processing section 160A is omitted in order to make the drawing eye-friendly.

For example, the image processing section 142 decodes the video data Dv received from the separation section 120, and then performs the image processing such as the resolution conversion process, the color compensation process and the keystone correction process on the video data Dv thus decoded. In other words, the image processing section 142 performs the image processing on the video data Dv received from the separation section 120.

The delay section 150A receives the audio data Da from, for example, the separation section 120. Then, the delay section 150A delays the audio data Da received from the separation section 120 in accordance with the content of the image processing by the image processing section 142, and then outputs the result to the output processing section 160A. In other words, the delay section 150A adjusts the delay amount from when the video data Dv and the audio data Da are separated from the stream data Dst to when the audio data Da2 is output to the sound output device 30 in accordance with the content of the image processing by the image processing section 142. The image processing by the image processing section 142 is an example of the image processing performed by the display processing section 140 on the video data Dv.

For example, when the display device 10C has a first processing mode in which the keystone correction process is performed and a second processing mode in which the keystone correction process is not performed, the content of the image processing by the image processing section 142 is different between the first processing mode and the second processing mode. In the first processing mode, since the keystone correction process is performed, the processing time of the image processing performed by the image processing section 142 is longer than in the second processing mode.

Therefore, when the processing mode of the display device 10C is the first processing mode, the delay section 150A sets the delay amount of the audio data Da larger than in the case in which the processing mode of the display device 10C is the second processing mode. In other words, the delay section 150A adjusts the delay amount of the audio data Da in accordance with the processing mode of the display device 10C so that the output delay time of the sound and the output delay time of the image are aligned with each other. It should be noted that an initial value of the delay amount of the audio data Da delayed by the delay section 150A is set in advance in accordance with the specification of the display device 10C and so on so that the output delay time of the sound and the output delay time of the image are aligned with each other.

The control section 180 controls the image processing section 142 so that the image processing based on the processing mode of the display device 10C is performed on the video data Dv. Further, the control section 180 notifies the delay section 150A of the processing mode of the display device 10C or the delay amount based on the processing mode of the display device 10C. It should be noted that the notification of the processing mode of the display device 10C corresponds to the notification of the content of the image processing, and the notification of the delay amount based on the processing mode of the display device 10C corresponds to the notification of the delay amount based on the content of the image processing.

As described hereinabove, also in the fourth embodiment, substantially the same advantages as in the third embodiment can be obtained. Further, in the fourth embodiment, the delay section 150A adjusts the delay amount of the audio data Da in accordance with the content of the image processing on the video data Dv performed by the display processing section 140. Therefore, even when, for example, the processing time of the image processing on the video data Dv becomes long, it is configured for the display device 10C to prevent the shift between the image to be displayed on the screen 40 and the sound to be output from the sound output device 30 from increasing.

### Fifth Embodiment

A major difference between the fifth embodiment and the fourth embodiment is a point that the delay amount of the audio data Da can be adjusted by the user.

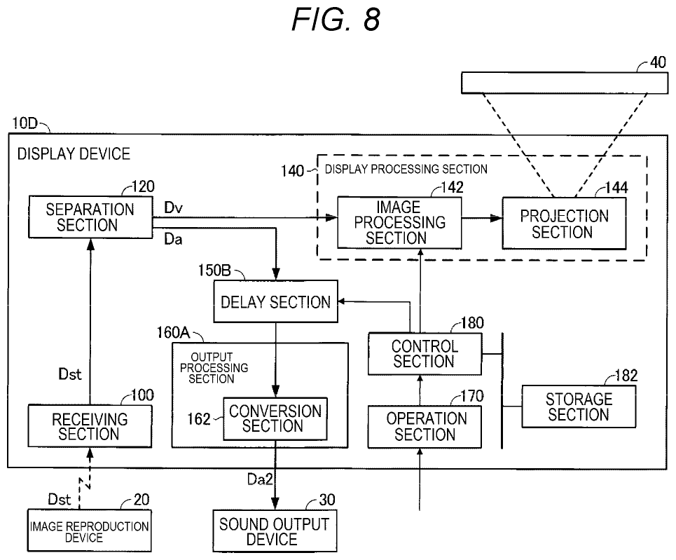

FIG. 8 is a block diagram showing a configuration of a display device 10D according to the fifth embodiment. The same elements as the elements having already been described with reference to FIG. 1 through FIG. 7 are denoted by the same reference numerals and the detailed description thereof will be omitted. In the display device 10D, an operation section 170 is added to the display device 10C. Further, the display device 10D has a delay section 150B instead of the delay section 150A shown in FIG. 7. The other constituents of the display device 10D are the same as in the display device 10C shown in FIG. 7. For example, the display device 10D has the receiving section 100, the separation section 120, the display processing section 140, the delay section 150B, the output processing section 160A, the operation section 170, the control section 180 and the storage section 182. The receiving section 100, the separation section 120, the display processing section 140, the output processing section 160A, the control section 180 and the storage section 182 are the same as those of the fourth embodiment. Therefore, in FIG. 8, the description will be presented with a focus on the delay section 150B and the operation section 170. It should be noted that also in FIG. 8, the description of the control lines for respectively connecting the control section 180 to the receiving section 100, the separation section 120, the projection section 144 and the output processing section 160A is omitted in order to make the drawing eye-friendly.

The operation section 170 receives an operation by the user. It should be noted that the operation section 170 can be an operation buttons or the like provided to a main body of the display device 10D, or can also be a remote controller for remotely operating the display device 10D. The control section 180 is notified by the operation section 170 of the content of the operation by the user. When the operation section 170 receives the operation by the user, the control section 180 notifies the delay section 150B of the content of the operation by the user, or the delay amount based on the content of the operation by the user. It should be noted that an initial value of the delay amount of the audio data Da delayed by the delay section 150B is set in advance in accordance with the specification of the display device 10D and so on so that the output delay time of the sound and the output delay time of the image are aligned with each other.

When the operating section 170 receives the operation of the delay adjustment for adjusting the delay amount of the audio data Da, the delay section 150B adjusts the delay amount of the audio data Da in accordance with the operation of the delay adjustment. Specifically, when the operating section 170 receives the operation of the delay adjustment for adjusting the delay amount of the audio data Da, the delay section 150B adjusts the delay amount from when the video data Dv and the audio data Da are separated from the stream data Dst to when the audio data Da2 is output to the sound output device 30 in accordance with the operation of the delay adjustment.

For example, when the operating section 170 receives the operation of the delay adjustment for increasing the delay amount of the audio data Da, the delay section 150B makes the delay amount of the audio data Da larger than the present delay amount. Alternatively, when the operating section 170 receives the operation of the delay adjustment for decreasing the delay amount of the audio data Da, the delay section 150B makes the delay amount of the audio data Da smaller than the present delay amount.

It should be noted that it is also configured for the delay section 150B to adjust the delay amount of the audio data Da in accordance with the content of the image processing by the image processing section 142 similarly to the delay section 150A shown in FIG. 7. In this case, the control section 180 notifies the delay section 150B of the processing mode of the display device 10D or the delay amount based on the processing mode of the display device 10D. Then, the delay section 150B adjusts the delay amount of the audio data Da in accordance with the content of the image processing by the image processing section 142. Further, when the operating section 170 receives the operation of the delay adjustment for adjusting the delay amount of the audio data Da, the delay section 150B adjusts the delay amount of the audio data Da in accordance with the operation of the delay adjustment.

For example, when the operating section 170 receives the operation of the delay adjustment for increasing the delay amount of the audio data Da, the delay section 150B makes the delay amount of the audio data Da larger than the present delay amount which has been adjusted in accordance with the content of the image processing. Alternatively, when the operating section 170 receives the operation of the delay adjustment for decreasing the delay amount of the audio data Da, the delay section 150B makes the delay amount of the audio data Da smaller than the present delay amount which has been adjusted in accordance with the content of the image processing.

In the display device 10D, since the delay amount of the audio data Da can be adjusted by the user, the shift between the image to be displayed on the screen 40 and the sound to be output from the sound output device 30 can be decreased to the extent that the user fails to sense the shift. For example, even when the positional relationship between the speaker and the user watching the image such as the screen 40 and the sound output device 30 is different due to the installation environment such as the size of the room or the hall in which the display device 10D is installed, it is configured for the user to reduce the shift between the image and the sound by operating the operation section 170.

As described hereinabove, also in the fifth embodiment, substantially the same advantages as in the fourth embodiment can be obtained. Further, in the fifth embodiment, the display device 10D has the operation section 170 for receiving the operation by the user. Further, when the operating section 170 receives the operation of the delay adjustment for adjusting the delay amount of the audio data Da, the delay section 150B adjusts the delay amount of the audio data Da in accordance with the operation of the delay adjustment . Therefore, in the display device 10D, it is configured to adjust the delay amount of the audio data Da with the operation by the user to thereby enhance the usability such as the user-friendliness.

### Sixth Embodiment

A major difference between the sixth embodiment and the fifth embodiment is a point that the delay amount of the audio data Da is adjusted in accordance with the format of the audio data Da.

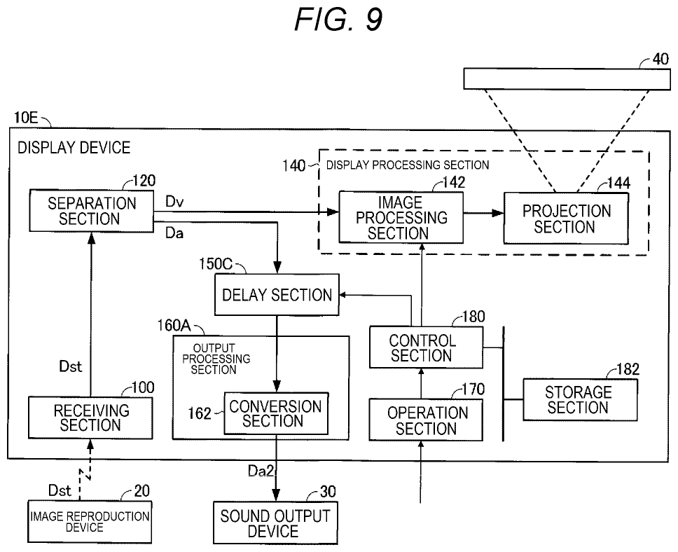

FIG. 9 is a block diagram showing a configuration of a display device 10E according to the sixth embodiment. The same elements as the elements having already been described with reference to FIG. 1 through FIG. 8 are denoted by the same reference numerals and the detailed description thereof will be omitted. The display device 10E is the same as the display device 10D shown in FIG. 8 except the fact that a delay section 150C is provided instead of the delay section 150B shown in FIG. 8. For example, the display device 10E has the receiving section 100, the separation section 120, the display processing section 140, the delay section 150C, the output processing section 160A, the operation section 170, the control section 180 and the storage section 182. The receiving section 100, the separation section 120, the display processing section 140, the output processing section 160A, the operation section 170, the control section 180 and the storage section 182 are the same as those of the fifth embodiment. Therefore, in FIG. 9, the description will be presented with a focus on the delay section 150C. It should be noted that also in FIG. 9, the description of control lines for respectively connecting the control section 180 to the receiving section 100, the separation section 120, the projection section 144 and the output processing section 160A is omitted in order to make the drawing eye-friendly.

The delay section 150C detects the format of the audio data Da received from the separation section 120. Then, the delay section 150C adjusts the delay amount of the audio data Da in accordance with the content of the image processing by the image processing section 142 and the format of the audio data Da. In other words, the delay section 150C adjusts the delay amount from when the video data Dv and the audio data Da are separated from the stream data Dst to when the audio data Da2 is output to the sound output device 30 in accordance with the content of the image processing by the image processing section 142 and the format of the audio data Da. The other operations of the delay section 150C are the same as those of the delay section 150B shown in FIG. 8.

For example, the processing time of the conversion process for converting the format of the audio data Da into the format compatible with ARC of the HDMI cable differs depending on the format of the audio data Da. Therefore, the delay section 150C adjusts the delay amount of the audio data Da in accordance with the processing mode of the display device 10E and the format of the sound data Da so that the output delay time of the sound and the output delay time of the image are aligned with each other. It should be noted that delay section 150C can also be notified of the format of the audio data Da by the separation section 120 or the like.

As described hereinabove, also in the sixth embodiment, substantially the same advantages as in the fifth embodiment can be obtained. Further, in the sixth embodiment, the delay section 150C adjusts the delay amount of the audio data Da in accordance with the format of the audio data Da. As a result, in the display device 10E, it is configured to prevent the shift between the image to be displayed on the screen 40 and the sound to be output from the sound output device 30 from varying due to the difference in the format of the audio data Da.

### MODIFIED EXAMPLES

Each of the first through sixth embodiments can variously be modified. Specific modified configurations will hereinafter be illustrated. Tow or more configurations arbitrarily selected from the following illustrations can arbitrarily be combined unless conflicting with each other.

### Modified Example 1

The receiving section 100 wirelessly receives the stream data Dst including the video data Dv and the audio data Da from the image reproduction device 20 in each of the first through sixth embodiments, but the transmission source of the stream data Dst is not limited to the image reproduction device 20. For example, it is also configured for the receiving section 100 to receive a moving image to be displayed on a web page or the like via the Internet using a wireless LAN as the stream data Dst including the video data Dv and the audio data Da. Also in Modified Example 1, substantially the same advantages as those of each of the first through sixth embodiments can be obtained.

### Modified Example 2

In each of the first through sixth embodiments, it is also configured for each of the display devices 10, 10A, 10B, 10C, 10D and 10E to have a built-in speaker. In this case, the output processing section 160 switches the output destination of the audio data Da between the sound output device 30 and the built-in speaker based on the control by the control section 180 or the like. Similarly, the output processing section 160A switches the output destination of the audio data Da2 between the sound output device 30 and the built-in speaker based on the control by the control section 180 or the like. It should be noted that it is also configured for the output processing section 160A to output the audio data Da to the built-in speaker without converting the format in the case of outputting the sound from the built-in speaker, and at the same time, the format of the audio data Da is a format compatible with the built-in speaker.

Further, it is also configured for each of the delay sections 150, 150A, 150B and 150C to adjust the delay amount of the audio data Da in accordance with the output destination of the audio data Da2. For example, the initial value of the delay amount of the audio data Da set in each of the delay sections 150, 150A, 150B and 150C can also be a value different between the case in which the output destination of the audio data Da2 is the built-in speaker and the case in which the output destination of the audio data Da2 is the sound output device 30. Also in Modified Example 2, substantially the same advantages as those of each of the first through sixth embodiments can be obtained.

### Modified Example 3

In the first embodiment, it is also configured for the output processing section 160 to have a conversion section for converting the audio data Da included in the stream data Dst into the audio data Da in another format. Also in this case, substantially the same advantages as in the first embodiment can be obtained. Further, in Modified Example 3, the sound output device 30 for decoding the audio data Da different in format from the audio data Da included in the stream data Dst can be connected to the display device 10, and thus, it is configured to enhance the usability such as the user-friendliness.

### Modified Example 4

In each of the second through sixth embodiments, it is also configured for the output processing section 160A to function as an interface compatible with a plurality of types of cables. For example, it is also configured for the output processing section 160A to have a plurality of types of terminals such as a terminal to which an optical cable compliant with the SPDIF standard is connected, a terminal to which a coaxial cable compliant with the SPDIF standard is connected, and a terminal to which an HDMI cable is connected. In this case, it is also configured for the conversion section 162 to convert the format of the audio data Da into the format compatible with the terminal to which the sound output device 30 is connected out of the plurality of types of formats including the format compatible with ARC of the HDMI cable to thereby generate the audio data Da2. Also in Modified Example 4, substantially the same advantages as those of each of the second through sixth embodiments can be obtained. Further, in Modified Example 4, it is configured to connect the sound output device 30 incompatible with ARC of the HDMI cable to each of the display devices 10A, 10B, 10C, 10D and 10E, and thus, it is configured to enhance the usability such as the user-friendliness.

### Modified Example 5

In each of the third through fifth embodiments, it is also configured for each of the display devices 10B, 10C and 10D to have the output processing section 160 instead of the output processing section 160A. Also in this case, substantially the same advantages as those of each of the fourth and fifth embodiments can be obtained.

### Modified Example 6

In each of the fourth through sixth embodiments, it is also configured for each of the delay sections 150A, 150B and 150C to adjust the delay amount of the audio data Da in accordance with the luminance of the light emitted from the light source not shown in the projection section 144. Also in this case, substantially the same advantages as those of each of the fourth through sixth embodiments can be obtained.

### Modified Example 7

The whole or a part of the function of each of the receiving section 100, the separation section 120, the display processing section 140, the delay sections 150, 150A, 150B and 150C, and the output processing sections 160, 160A can also be realized by software executed by the CPU or the like. Alternatively, the whole or a part of the function of each of the receiving section 100, the separation section 120, the display processing section 140, the delay sections 150, 150A, 150B and 150C, and the output processing sections 160, 160A can also be realized by hardware using an electronic circuit such as an FPGA (Field Programmable Gate Array) or an ASIC (Application Specific IC). Alternatively, the whole or apart of the function of each of the receiving section 100, the separation section 120, the display processing section 140, the delay sections 150, 150A, 150B and 150C, and the output processing sections 160, 160A can also be realized by a cooperative operation of the software and the hardware.

### Modified Example 8

Some or all of the elements realized by the control section 180 retrieving and then executing the program can also be realized by hardware using an electronic circuit such as an FPGA or an ASIC, or can also be realized by a cooperative operation of the software and the hardware.

### Modified Example 9

In each of the first through sixth embodiments, each of the display devices 10, 10A, 10B, 10C, 10D and 10E is not limited to the projector. For example, each of the display devices 10, 10A, 10B, 10C, 10D and 10E can also be a direct-view display such as a liquid crystal display or a plasma display.

What is claimed is:

1. A display device comprising:
a receiving section configured to wirelessly receive stream data including video data and audio data;
a separation section configured to separate the video data and the audio data from the stream data;
a display processing section configured to display an image based on the video data; and
an output processing section configured to output the audio data to a sound output device which is connected to the display device with wire.

2. The display device according to claim 1, wherein
the output processing section includes a conversion section configured to convert the audio data into data in a format compatible with Audio Return Channel of an HDMI cable, and outputs the audio data converted in the format by the conversion section to the sound output device.

3. The display device according to claim 1, further comprising:
a delay section configured to delay the audio data having been separated from the video data.

4. The display device according to claim 3, wherein
the delay section adjusts a delay amount of the audio data in accordance with a content of image processing on the video data performed by the display processing section, and
the display processing section performs the image processing on the video data to generate the image based on the video data.

5. The display device according to claim 3, further comprising:
an operation section configured to receive an operation of a delay adjustment for adjusting the delay amount of the audio data by a user, wherein
the delay section adjusts a delay amount of the audio data in accordance with the operation of the delay adjustment when the operation section receives the operation of the delay adjustment.

6. The display device according to claim 3, wherein
the delay section adjusts a delay amount of the audio data in accordance with a format of the audio data.

7. A method of controlling a display device to be connected to a sound output device with wire, the method comprising:
receiving wirelessly stream data including video data and audio data;
separating the video data and the audio data from the stream data;
displaying an image based on the video data; and
outputting the audio data to the sound output device.
